(19) United States
(12) Patent Application Publication
(10) Pub. No.: US 2026/0367036 A1
(43) Pub. Date: Nov. 19, 2026

(54) Capillary Electrophoresis Device and Capillary Cartridge

(71) Applicants: IntegenX, Inc., Pleasanton, CA (US); Hitachi High-Tech Corporation, Minato-ku, Tokyo (JP)

(72) Inventors: Tsutomu BABA, Tokyo (JP); Taro NAKAZAWA, Tokyo (JP); Yukio TOMINAGA, Tokyo (JP); Shuhei YAMAMOTO, Tokyo (JP); Ryoji INABA, Tokyo (JP)

(21) Appl. No.: 19/133,815

(22) PCT Filed: Nov. 30, 2022
(86) PCT No.: PCT/JP2022/044214

§ 371 Date: May 29, 2025

(51) Int. Cl. G01N 27/447

(52) U.S. Cl. CPC G01N 27/44704

(57) ABSTRACT

A capillary electrophoresis device is provided which is capable of exchanging a capillary with ease. The capillary electrophoresis device includes: a capillary cartridge 102 in which a capillary 101 is positioned; a first structural body 106 in which a flow path to which one end of the capillary is connected is formed; and a second structural body 107 in which a flow path to which the other end of the capillary is connected is formed, and the capillary electrophoresis device is so configured that at least any one of the first structural body or the second structural body is movable within a predetermined range.

### TECHNICAL FIELD

This invention relates to a capillary electrophoresis device and a capillary cartridge.

### BACKGROUND ART

With respect to a capillary used in a capillary electrophoresis device, when the electrophoresis is repeatedly performed, a residue of a sample is accumulated in the capillary or a coating in the capillary is deteriorated and hence, the separation performance is lowered. Accordingly, when the electrophoresis is performed a predetermined number of times, it is necessary to exchange a capillary.

In view of the background of such a technical field, there has been proposed a technique described in Patent Literature 1. In the abstract of this publication, there is the following description. To provide a small-sized capillary electrophoresis device that eases a capillary exchange operation, there is provided a capillary electrophoresis device that includes: an electrophoresis unit 3 in which electrodes are disposed on both end portions of the capillary 2; a sample liquid conveyance unit 7 that conveys sample liquids to both end portions of the capillary 2; a capillary holding portion 4 that is formed of two plates that are configured to clamp the capillary 2 and are configured to be removable from the device; a sample liquid detection unit 5 that acquires information on electrophoresis from a through hole which is provided at a portion of the capillary holding portion 4; and a temperature control unit 6 that controls a temperature of the capillary holding portion 4. Since a ceiling of a housing 1 that forms an upper portion of the capillary holding portion 4 is openable and closable and hence, the capillary 2 can be easily taken out.

### CITATION LIST

### Patent Literature

Patent Literature 1: Japanese Unexamined Patent Application Publication No. 2008-008808

### SUMMARY OF INVENTION

### Technical Problem

In the above-mentioned Patent Literature 1, in a case of exchanging the capillary, it is necessary to perform the following operation. The ceiling of the openable and closable housing can be opened, the parts that clamp the capillary are removed and, thereafter, the capillary is disposed in a groove formed on the temperature control unit, and both ends of the capillary are connected to a flow path. As a result, a mounting operation of the capillary becomes difficult.

The present invention has been made in view of the above-mentioned circumstances, and it is an object of the present invention to provide a capillary electrophoresis device capable of exchanging a capillary with ease.

### Solution to Problem

To overcome the above-mentioned drawbacks, the present invention adopts the configurations called for in claims, for example. The present invention includes plural means for solving the above problems, and one example thereof is a capillary electrophoresis device. The capillary electrophoresis device includes: a capillary cartridge in which a capillary is positioned; a first structural body in which a flow path to which one end of the capillary is connected is formed; and a second structural body in which a flow path to which the other end of the capillary is connected is formed. At least any one of the first structural body or the second structural body is movable within a predetermined range.

### Advantageous Effects of Invention

According to the present invention, it is possible to provide a capillary electrophoresis device capable of exchanging a capillary with ease. Objects, configurations, and effects other than the above will be apparent from the description of the following embodiments.

### BRIEF DESCRIPTION OF DRAWINGS

FIG. 1 is a schematic view of an outline of a capillary electrophoresis device according to a first embodiment.

FIG. 2 is an exploded view of the capillary cartridge according to the first embodiment.

FIG. 3 is a cross-sectional view of the capillary cartridge according to the first embodiment.

FIG. 4A is a schematic view of a method of mounting the capillary cartridge according to the first embodiment.

FIG. 4B is a schematic view of a method of mounting the capillary cartridge according to the first embodiment.

FIG. 4C is a schematic view of a method of mounting the capillary cartridge according to the first embodiment.

FIG. 4D is a schematic view of a method of mounting the capillary cartridge according to the first embodiment.

FIG. 5 is a schematic view of a method of mounting the capillary cartridge when both structural bodies according to the first embodiment are movable.

FIG. 6 is a schematic view of a mechanism that enables the structural body according to the first embodiment to move in an axial direction of a capillary.

FIG. 7 is a schematic view of the configuration where a structural body according to a second embodiment is movable in a θ direction.

FIG. 8 is a schematic view of the configuration where a structural body includes a protruding portion that fixes a capillary cartridge according to a third embodiment.

FIG. 9 is a schematic view of the configuration that includes a holding jig that limits the rotation of the structural body according to the third embodiment.

FIG. 10 is a schematic view of the configuration that enables the mounting and the removal of a capillary cartridge according to a fourth embodiment by a latch-lock.

### DESCRIPTION OF EMBODIMENTS

Hereinafter, the mode for carrying out the present invention will be sequentially described with reference to the drawings.

### First Embodiment

In the first embodiment, an embodiment of a capillary electrophoresis device having the following configuration is described. That is, the capillary electrophoresis device includes: a capillary cartridge where a capillary is positioned; a first structural body where a flow path to which one end of the capillary is connected is formed; and a second structural body where a flow path to which the other end of the capillary is connected is formed. At least any one of the first structural body or the second structural body is movable, that is, can be moved within a predetermined range.

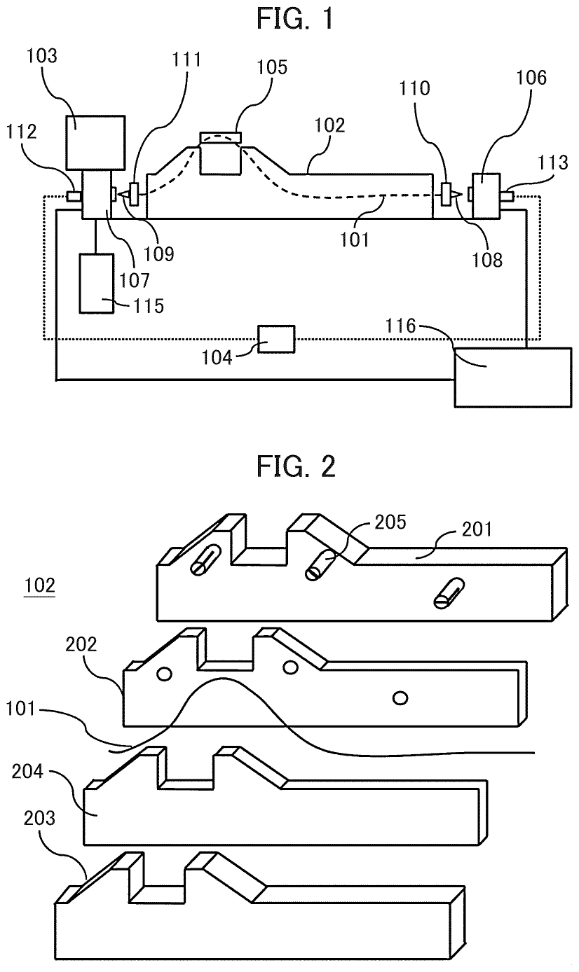

FIG. 1 illustrates an outline of a capillary electrophoresis device according to this embodiment. The capillary electrophoresis device according to this embodiment includes: one or a plurality of capillaries 101; a capillary cartridge 102 that performs holding of the capillary 101 and a temperature control of the capillary 101; a first structural body 106 and a second structural body 107 having flow paths that are connected to the capillary 101; a gel supply unit 103 for filling a gel into the capillary through the first structural body or the second structural body; and a high-voltage power supply 104 for applying a high voltage to the capillary. The capillary cartridge 102, the first structural body 106, and the second structural body 107 are mounted on a predetermined board.

The capillary 101 is a glass tube whose surface is protected by coating made of polyimide. The capillary 101 has an inner diameter of several tens μm and an outer diameter of several hundred μm. The capillary 101 is an integral body formed of a first capillary head 108, a second capillary head 109, a first capillary head pressing member 110, a second capillary head pressing member 111, and a detection window 105

The first capillary head 108 is connected to the first structural body 106, and the second capillary head 109 is connected to the second structural body 107. In such a configuration, the connection between the first structural body and the first capillary head, and the connection between the second capillary head 109 and the second structural body are respectively fixed by the first capillary head pressing member 110 or the second capillary head pressing member 111.

A method of fixing the first structural body and the first capillary head by the first capillary head pressing member is described. Threads are formed on an inside of the first capillary head pressing member 110, and threads are formed on an outside of the first structural body 106 so as to enable the first structural body 106 to be connected to the first capillary head pressing member 110. When the threads are fastened to each other, the first capillary head 108 is pressed to the first structural body 106. Further, at least a portion of an inserting portion of the first capillary head 108 and an insertion opening of the capillary head of the first structural body are formed into a tapered structure, and are brought into contact with each other thus preventing leakage of a gel at the time of filling the gel. The description has been made by taking the first capillary head pressing member as an example. However, a method of fixing by the second capillary head pressing member is substantially equal. By fastening the threads formed on the second capillary head pressing member 111 and the threads formed on the second structural body to each other, the second capillary head is pressed to the second structural body and hence, the second capillary head and the second structural body are fixed.

Further, the first capillary head pressing member 110 and the second capillary head pressing member 111 also play a role of handles at the time of connecting the capillary head to the structural body. At the time of exchanging the capillary 101, it is unnecessary for an operator to touch a distal end of the capillary 101 and hence, a contamination risk of the capillary 101 can be reduced. In this embodiment, the description has been made with respect to the example where the threads are formed on the inside of the capillary head pressing member and the outside of the structural body. However, it is sufficient that the threads are formed so as to threadedly engage with each other, and the threads may be formed on the outside of the capillary head pressing member and the inside of the structural body.

Further, the second structural body 107 is connected to a gel filling unit 103 and a gel supply unit. A gel is supplied to the inside of the second structural body 107 by a gel supply unit 115 and, thereafter, the gel supplied to the second structural body by the gel filling unit 103 is fed to the capillary 101 and the first structural body. The first structural body and the second structural body are connected to a waste liquid tank 116. For example, a used gel passes the first structural body due to feeding of a new gel so that the used gel is fed to the waste liquid tank. Although the illustration is omitted in FIG. 1, a sample and a reagent are supplied to the first structural body or the second structural body, and the used sample and the used reagent are fed to the waste liquid tank 116 and accommodated in the waste liquid tank 116.

Further, the first structural body 106 is connected to a cathode 113, and the second structural body 107 is connected to an anode 112. The anode 112 and the cathode 113 are connected to a high voltage power supply. Accordingly, when a voltage is applied to the cathode and the anode in a state where a gel is filled in the capillary, the first structural body and the second structural body, the gels in flow paths of the first structural body and the second structural body and the gel in the capillary are electrically connected to each other. When a sample that is charged negatively is supplied to the first structural body 108 in a state where the gel is filled in the first structural body 108, and a voltage is applied to the anode 112 and the cathode 113 by the high voltage power supply, electrophoresis of the sample toward the anode 108 is generated. When the sample passes through the capillary 101 and reaches a detection window 105, the sample is detected by a detection unit not illustrated in the drawing.

In this embodiment, the capillary 101 is held in a state where the capillary 101 is positioned in a capillary cartridge 102. Further, the capillary cartridge 102 has a heater, and the heater controls a temperature of the capillary 101 to a predetermined temperature.

In the capillary electrophoresis device, an effect of Joule heat is reduced by making use of high heat radiation performance of the capillary to thereby enhance the separation performance. In general, as a technique for performing a temperature control, a technique that uses a planar heater whose temperature is controlled on a surface of the capillary, and a technique that circulates air whose temperature is controlled to a fixed temperature in a space where the capillary is disposed, are named. In this embodiment, the former planar heater is adopted.

FIG. 2 is an example of an exploded view of the capillary cartridge 101 of this embodiment. The capillary cartridge 101 has a multi-layered structure comprised of a heat insulation material shell 201, a heat insulation material 202, the capillary 101, a heater shell 203, and a heater unit 204. The heat insulation material shell means a shell on a heat insulation material side, and the heater shell means a shell on a heater side.

The heat insulation material shell 201 is a case of the capillary cartridge 102, and has a guide structure 205 for positioning and holding the capillary 101. The guide structure 205 is a columnar structural body having a cut-away portion. The guide structure 205 holds the capillary by arranging the capillary inside the cut-away portion. The heat insulation material 202 and the heater unit 204 each have a hole and a recessed portion for inserting the guide structure 205. By inserting the guide structure 205 in the holes in a state where the capillary 101 is positioned in the cut-away portion formed on the guide structure 205, the capillary 101 is disposed on the heater. In a case where there exist irregularities in temperature or there exists the difference in being affected by outside air depending on the position of the planar heater, the capillary cannot be disposed at the same position at the time of exchanging the capillary. In such a case, irregularities occur in accuracy of a temperature control of the capillary thus giving rise to a possibility that irregularities occur in an analysis performance. In this embodiment, due to the provision of the guide structure 205, even when the capillary 101 is mounted or removed, the capillary can be arranged at the same position in the heater and hence, irregularities in temperature due to the position of the capillary arranged in the heater can be reduced. As a result, irregularities in performance between the capillary cartridges before and after exchanging the capillary can be reduced. Accordingly, it is possible to acquire the stable analysis performance.

As a method of arranging the capillary on the heater surface with favorable reproducibility, there are considered, as described in Patent Literature 1, for example, a method that forms a groove on a path where the capillary on the heat radiation sheet is to be arranged, and a method where the capillary is laminated to a heat radiation sheet using a seal or the like. However, in the former method, it is difficult to arrange the capillary on a curved line as illustrated in FIG. 1. This is because elasticity of the capillary is large and hence, the shallow groove cannot hold the capillary. On the other hand, when the groove is formed of a deep groove, it is difficult to bring the capillary into contact with the heater thus giving rise to a possibility that irregularities occur in temperature. In this embodiment, the guide structure is inserted into the planar heater in a state where a portion of the capillary 101 is held by the guide structure 205 and hence, it is possible to bring the capillary 101 into contact with the heater in a stable manner whereby irregularities in temperature can be reduced.

Further, in the latter method, in a case where the capillary is positioned by laminating the seal, a dedicated jig or the like becomes necessary for laminating the seal at a predetermined position. In this embodiment, the capillary 101 can be positioned by the guide structure 205 mounted on the heat insulation material shell described above. Accordingly, the capillary can be easily fixed on a desired curved line with favorable reproducibility. In addition, a region of the capillary held by the guide structure is extremely narrow, that is, several mm and hence, a risk that affects an analysis result can be made small compared to a case where the capillary is fixed by the seal.

The heat insulation material 202 prevents heat from the heater unit 204 from leaking to the outside thus reducing an effect that a temperature in the capillary cartridge 102 receives from an outside temperature. In addition, the heat insulation material 202 is formed of a soft material. Accordingly, when the heat insulation material shell 201 and the heater shell 203 are closed, the heat insulation material 202 is depressed and hence, the capillary 101 is pressed to the heater unit 204. As a result, the capillary 101 can efficiently perform a heat exchange with the heater unit 204.

The heater shell 203 is a case of the capillary cartridge 101. Unlike the heat insulation material shell 201, the heater shell 203 does not have the guide structure 205. A width of a space in the shell that is formed by closing the heat insulation material shell 201 and the heater shell 203 is smaller than a total of a thickness of the heat insulation material 202 and a thickness of the heater unit 204. This is because an efficiency of a heat exchange can be enhanced by strongly pressing the capillary 101 described above to the heater unit 204.

The heater unit 204 has a temperature senser on a surface thereof on a capillary 101 side, and a surface of the heater unit 204 with which the capillary 101 is brought into contact can be controlled to a predetermined temperature by the temperature senser.

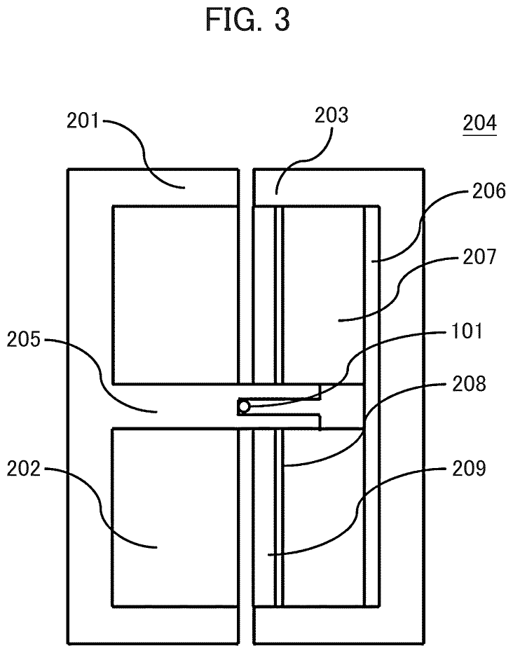

FIG. 3 illustrates one example of the cross-sectional view of the capillary cartridge according to this embodiment. The heat insulation material shell 201 is illustrated on a left side of the drawing, and the heater shell 203 is illustrated on a right side of the drawing. The heater unit 204 disposed in the heater shell 203 has a multi-layered structure consisting of a planar heater 206, a metal plate 207, an insulation sheet 208, and a heat radiation sheet 209. The heater unit 204 has a groove with which the guide structure 205 engages.

The planar heater 206 is controlled by a temperature senser not illustrated in the drawing that is disposed on the heat radiation sheet 209, and performs a temperature control of the heat radiation sheet 209 to a predetermined temperature. The metal plate 207 diffuses heat from the planar heater in plane thus making a temperature on the surface uniform. Further, a material of the metal plate 207 is metal having a large heat capacity and hence, the metal plate 207 is minimally affected by disturbance. The insulation sheet 208 is a sheet made of a material having a large electric resistance and hence, the insulation sheet 208 prevents discharging of electricity from the capillary 101 to which a high voltage is applied to the metal plate 207.

The heat radiation sheet 209 is a sheet made of a material having large thermal conductivity, and enhances an efficiency of heat exchange between the capillary 104 and the heater unit 204. The capillary electrophoresis device, by making use of a high heat radiation property of the capillary, decreases an effect of Joule heat thus enhancing a separation performance. In general, as a technique for performing a temperature control, a technique that uses a planar heater whose temperature is controlled on a surface of the capillary, and a technique that circulates air whose temperature is controlled to a fixed temperature in a space where the capillary is disposed, are named. In this embodiment, the description has been made by taking the planar heater as an example. However, it is sufficient that a temperature control can be performed and hence, an air circulation type temperature control may be adopted.

In this embodiment, the description has been made with respect to the positioning of the capillary on the capillary cartridge. However, the capillary cartridge may be provided to a user as an exchanging member. In this case, it is unnecessary for the user to perform positioning for the capillary with respect to the heater and hence, the mounting and the removal of the capillary can be performed more easily.

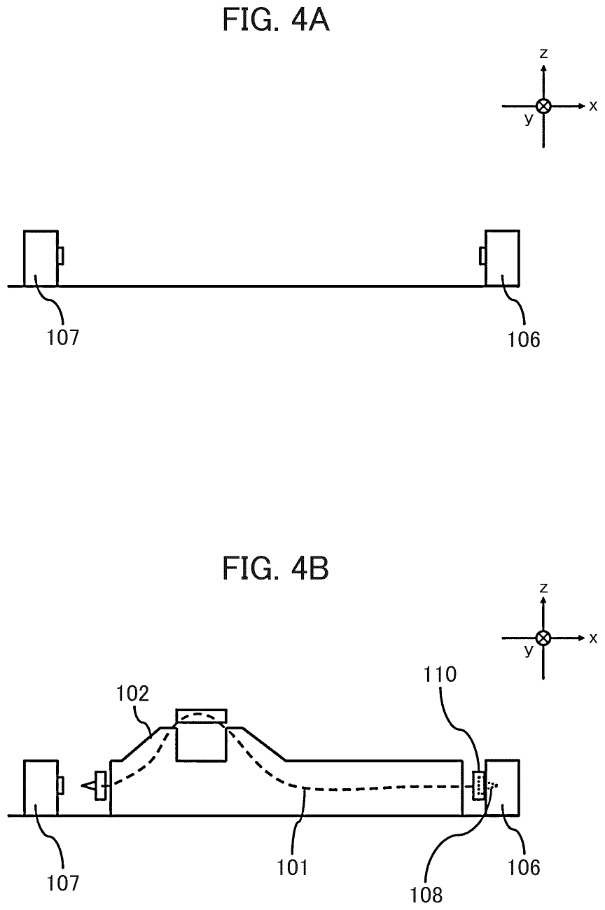

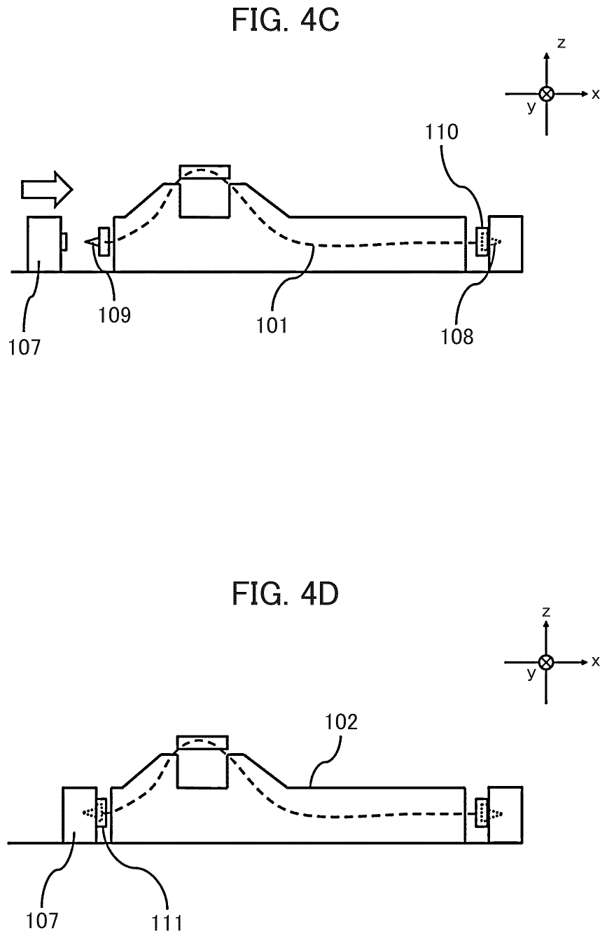

FIG. 4A to FIG. 4D are views illustrating one example of a method of mounting the capillary cartridge 102 of the first embodiment. In this embodiment, as described above, it is sufficient that at least any one of the first structural body 106 or the second structural body 107 is movable. Hereinafter, the mounting steps of the capillary cartridge 102 when only the second structural body 107 is movable in an x direction are described.

First, FIG. 4A illustrates a state where the first structural body 106 and the second structural body 107 are disposed on the board in the device, or a state where the capillary cartridge is removed. The second structural body 107 is movable within a predetermined range, and the second structural body 107 is moved such that connecting portions of the first structural body and the second structural body with the capillary heads are disposed at positions away from the capillary heads positioned at the capillary cartridge 102 by a distance of the capillary head. That is, the first structural body 106 and the second structural body 107 are disposed at positions where the first structural body 106 and the second structural body 107 do not interfere with the capillary at the time of mounting the capillary cartridge.

Then, the capillary cartridge 102 is moved in the x direction as illustrated in FIG. 4B, and is connected to the first structural body 106. As described above, by fastening the first capillary head pressing member 110 in a state where the first structural body 106 and the first capillary head 108 are connected to each other, the first structural body 106 and the first capillary head 108 are fixed so as to connect a flow path formed in the first structural body 106 and the capillary 101 with each other.

Next, the second structural body 107 is moved in the x direction as illustrated in FIG. 4C so as to connect the second structural body 107 to the second capillary head 109.

Finally, a flow path is connected to the second structural body 107 illustrated in FIG. 4D by fastening the second capillary head pressing member 111 as described above.

In a case where the first structural body 106 and the second structural body 107 are fixed and are not movable, it is necessary to connect the capillary with any the first structural body or the second structural body by deflecting the capillary, or it is necessary to remove at least any one of the first structural body or the second structural body.

In a case where any one of the first structural body 106 or the second structural body 107 is movable, when the capillary is integrally formed as the capillary cartridge, the capillary can be mounted or removed even in a state where the capillary is not deflected and hence, a temperature control region of the capillary can be widened and hence, a stable analysis performance can be acquired. In a case where the first structural body 106 and the second structural body 107 are fixed, by shortening the capillary cartridge 102 thus increasing lengths of regions of the capillary 101 protruding from the capillary cartridge 102, without removing both structural bodies by deflecting the capillary 101, the capillary cartridge 102 can be exchanged. In this case, however, a temperature control region of the capillary 101 is decreased and hence, an analysis performance is lowered. Further, in a case where the structural bodied are removed and the capillary cartridge is mounted, an exchanging operation becomes cumbersome. In this embodiment, by making the structural body movable, an exchange of the capillary cartridge 102 can be performed easily while ensuring a temperature control region at maximum.

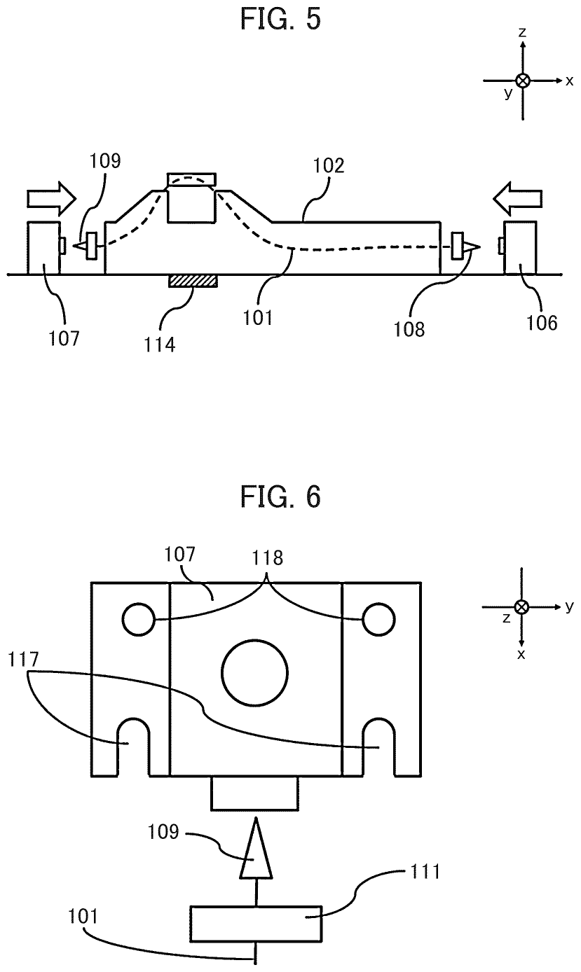

Next, the description is made with respect to steps of mounting in a case both of the first structural body and the second structural body are movable. In this case, as illustrated in FIG. 5, first, the capillary cartridge 102 may be mounted on the board at a predetermined position and, thereafter, both structural bodies may be respectively moved to the capillary head and may be connected to the capillary head. When the structural bodies are moved, the capillary cartridge 102 is disposed at the position where the structural bodies and the capillary head are connected to each other. In the drawing, a connector 114 of a heater disposed in the capillary cartridge 102 performs positioning of the capillary cartridge. In the drawing, the connector 114 is used for positioning the capillary cartridge.

However, a guide, a marker or the like may be used for such positioning of the capillary cartridge. A method of fixing the capillary head pressing member is substantially equal to the method described above. In this method, a mechanism that can move both structural bodies becomes necessary. However, it is unnecessary to move the capillary cartridge 102 in the x direction. Accordingly, the connector 114 of the heater disposed in the capillary cartridge 102 can be mounted just below the capillary cartridge 102 as illustrated in FIG. 5 and hence, the capillary cartridge 102 can be exchanged more easily.

Although not illustrated in FIG. 4, in a case where only the structural body on one side is movable, to move the capillary cartridge 102 in the x direction, it is necessary to connect the capillary cartridge 102 to the connector by extending a harness from the capillary cartridge 102.

Further, in a case where the capillary 101 is not positioned by the capillary cartridge 102, it is necessary to perform positioning with the first structural body 106, the second structural body 107 and the heater unit respectively and hence, mounting of the capillary becomes extremely cumbersome. With respect to the configuration of the capillary cartridge according to this embodiment, the capillary and the heater are integrally formed in a positioned state and hence, mounting and removal of the capillary can be performed easily. Further, by providing the movable structural body, it is possible to perform the exchange of the capillary cartridge in a state where the temperature control region is secured.

FIG. 6 is an example of a schematic view of a mechanism that enables the movement of the structural body provided with a flow path according to this embodiment. For example, such a mechanism can be realized in such a manner as described in FIG. 6 where among threaded holes formed at four corners for fixing the second structural body 107 provided with the flow path, two threaded holes are formed into cut-away holes 117 and remaining two threaded holes are formed into normal threaded holes 118. In this case, the cut-away holes 117 function as guides and hence, the structural body can be moved within a predetermined range.

In moving the second structural body, first, when screws in the normal threaded holes 118 are removed and screws in the cut-away holes 117 are loosened, the cut-away holes 117 restrict the movement of the second structural body in a y direction and in a z direction and hence, the second structural body is movable only in the x direction of the capillary 101. The shape of the cut-away hole 117 and the shape of the normal threaded hole 118 are not limited to the above-mentioned configurations. All four threaded holes may be formed into cut-away holes 117. Alternatively, elongated circular holes may be formed in place of the cut-away holes. In the configuration illustrated in FIG. 6 that is constituted of the cut-away holes 117 and the normal threaded holes 118, the configuration uses the normal threaded holes 118 and hence, the second structural body possesses excellent positioning accuracy. On the other hand, the configuration where all four threaded holes are formed into cut-away holes, it is unnecessary to completely remove the screws and hence, the exchange of the capillary can be performed more easily.

Accordingly, in mounting or removing the capillary cartridge 102, the connection between the first capillary head pressing member 110 and the second capillary head 111 is cancelled, and at least one of the first structural body 106 and the second structural body 107 may be moved. In this embodiment, the screws and the cut-away holes are used as guides. However, it is sufficient to limit the movement of the second structural body only in the x direction and hence, other configurations may be also adopted.

### Second Embodiment

In the second embodiment, an embodiment of a capillary electrophoresis device is described where, in the electrophoresis device according to the first embodiment, at least one of the first structural body 106 and the second structural body 107 is rotatable about a shaft portion, that is, is movable within a predetermined range in a θ direction. In this embodiment, the configuration other than a structural body portion is substantially equal to the corresponding configuration of the first embodiment.

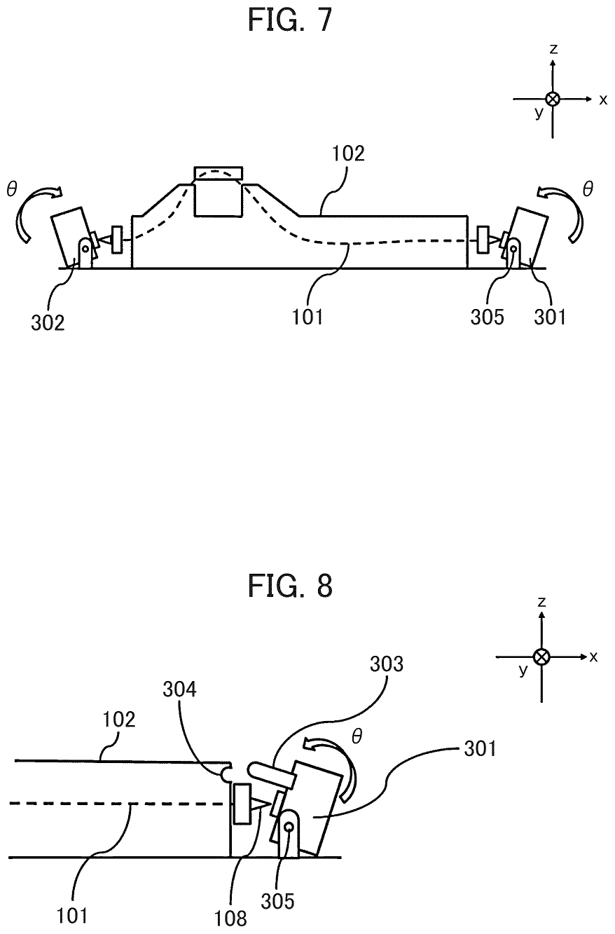

FIG. 7 is an example of a schematic view illustrating the configuration where a structural body is movable in a θ direction. As illustrated in FIG. 7, the configuration is adopted where both structural bodies 301, 302 are rotatable in the θ direction. To be more specific, the structural bodies are mounted on a device by structural body fixing portions fixed to a board of a device. The structural body fixing portion has a shaft portion 305 that engages with the structural body, and the structural body is rotatable about the shaft portion 305, that is movable in the θ direction. A capillary cartridge is disposed, and the structural bodies and a capillary head are connected to each other by moving the structural bodies in the θ direction. Further, the connection between the structural bodies and the capillary head is fixed by the capillary head pressing members in the same manner as the first embodiment.

The first structural body 301 that is movable in the θ direction in the embodiment and the second structural body 302 that is movable in the θ direction in the embodiment are rotatable about the shaft portions 305 as illustrated in FIG. 7. Accordingly, compared to the configuration of the first embodiment where it is necessary to loosen the screws that fix the structural bodies, the capillary cartridge 102 can be exchanged more easily.

To remove the capillary cartridge 102, the connection between the first capillary head pressing member 110 and the first structural body 301 that is movable in the θ direction is cancelled, the first structural body 301 that is movable in the θ direction is moved in the θ direction and, then, the same operation is performed on a side where the second structural body 302 is movable in the θ direction. Thereafter, the capillary cartridge 101 can be exchanged with a new capillary cartridge 101 by performing reverse steps.

### Third Embodiment

The third embodiment is an embodiment of a capillary electrophoresis device having the configuration where the first structural body that is rotatable about a shaft portion, that is, is movable within a predetermined range in the θ direction further includes a protruding portion, and the capillary cartridge has a recessed portion that engages with the protruding portion. The configuration of this embodiment is equal to the configuration of the first embodiment except for the protruding portion and the recessed portion.

In this embodiment, in the same manner as the first embodiment, the capillary head and the first structural body are fixed by the capillary head pressing member. According to this embodiment, the connection between the first structural body and the capillary head can be made more stable. Particularly, in feeding a gel by a gel filling unit 103, the gel has high viscosity and hence, a strong feeding pressure is applied for feeding the gel. Accordingly, in a case where a force generated in the structural body due to a pressure at the time of feeding the gel is displaced from a rotational axis of the structural body, such a force acts in the direction that the structural body rotates due to a feeding pressure. As a result, there is a possibility that the structural body rotates in the direction away from the capillary head. In a case where the connection of the first structural body and the second structural body with the capillary head by the capillary head pressing member is weak, the connection between the capillary head and the structural body is cancelled at the time of feeding the liquid and hence, there is a possibility that the liquid leaks. Further, when the structural body rotates in the direction away from the capillary head in a state where the capillary head and the structural body are fixed to each other, there is a possibility that the capillary breaks.

In view of the above, in this embodiment, as illustrated in FIG. 8, a protruding portion 303 is formed on the first structural body 301 that is rotatable about a shaft portion, that is, is movable in the θ direction, and a recessed portion 304 that engages with the protruding portion 303 is formed on the capillary cartridge 102. With such a configuration, it is possible to limit the rotation of the first structural body 301. Accordingly, the connection between the capillary head and the structural body can be made more stable, or it is possible to prevent breaking of the capillary 101.

In connecting the first structural body 301 with the capillary head by moving the first structural body 301 in the θ direction, the protruding portion 303 and the recessed portion 304 engage with each other. Due to the engagement between the protruding portion 303 and the recessed portion 304, it is possible to limit the rotation of the first structural body 301 after the first structural body 301 and the capillary head are connected to each other.

In this embodiment, the protruding portion is formed on the structural body and the recessed portion is formed on the capillary cartridge 102. However, the protruding portion may be formed on the capillary cartridge 102 and the recessed portion may be formed on the structural body. That is, it is sufficient that the structural body and the capillary cartridge 102 have the structure where these members engage with each other, and rotation of the structural body can be limited when these members engage with each other.

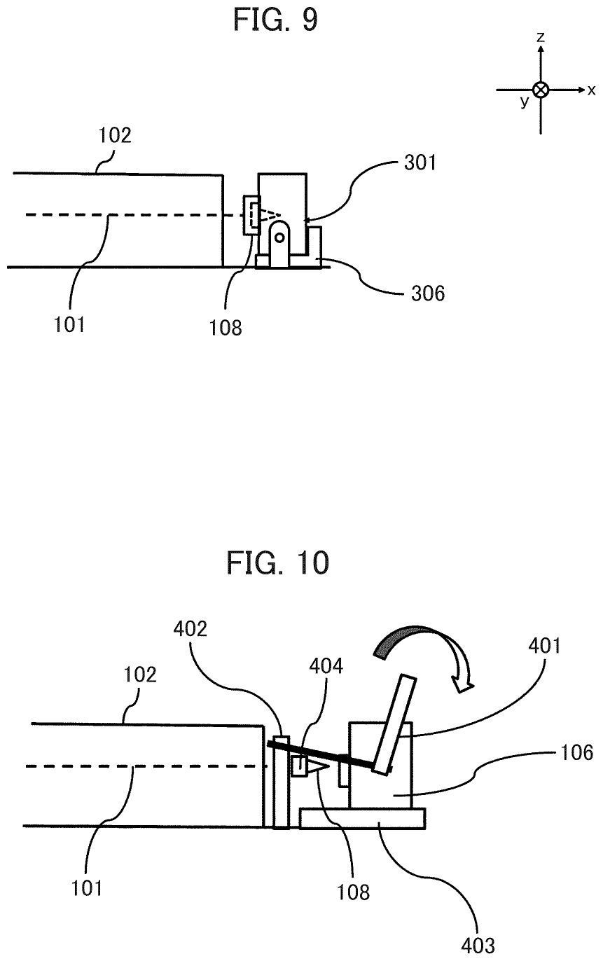

As a method of limiting the rotation of the structural body other than the structure where the structural body and the capillary cartridge engage with each other, as illustrated in FIG. 9, a holding jig 306 may be provided. By rotating the structural body 301 in the θ direction and by arranging the holding jig 306 after the connection of the structural body 301 with the capillary head, the rotation of the structural body 301 in the direction away from the capillary head is limited and hence, it is possible to hold the first structural body 301 in a state where the first structural body 301 is connected to the capillary head in a stable manner.

In this embodiment, the description is made by taking the first structural body 301 as an example. However, the same goes for the second structural body 302 in a case where the second structural body 302 is movable.

### Fourth Embodiment

The fourth embodiment is an embodiment where an alternative member is used in place of the above-mentioned capillary head pressing member. That is, the connection between the capillary head and the structural body is fixed by a latch-lock. The latch-lock can be used in a case where the first structural body 106 or the second structural body 107 is movable in the x direction. Further, in the first embodiment, the cut-away holes and the screws are used. In this embodiment, a guide structure 403 is provided, and the structural body has a recessed portion that engages with the guide structure. With the provision of the guide structure 403, the movement of the structural body in the z direction and the y direction is limited, and the structural body is movable within a predetermined range.

FIG. 10 is one example of a schematic view of this embodiment where the capillary cartridge can be mounted or removed using the latch-lock. As illustrated in the drawing, this embodiment includes: a latch-lock 401 for fixing the capillary cartridge; and a structural body 402 for hooking the latch-lock 401. Further, a rubber plug 404 is fixed to the capillary cartridge 102 of this embodiment. Other configurations of this embodiment are equal to the corresponding configurations of the first embodiment.

A first structural body 106 that is movable in the horizontal direction includes the latch-lock 401 for connecting the first capillary head 108 with a flow path, and has the guide structure 403 of the structural body for limiting the movement of the capillary 101 other than the directions parallel to an axis of the capillary 101.

The structural body 402 that engages with the latch-lock 401 has a slit through which the capillary 101 passes, and the capillary 101 becomes parallel to the flow path in the first structural body 106 without being deflected due to an elastic force of the rubber plug 404 disposed behind the first capillary head 108. When the latch-lock 401 is fastened in such a state, the first structural body 106 is pressed to the first capillary head 108 and is connected to the flow path. Accordingly, it is unnecessary to provide the capillary head pressing member. Unlike other examples where the screws of the capillary head pressing member is fastened, in this embodiment, the capillary 101 is connected to the flow path by only pulling the latch-lock 401 and hence, an exchange of the capillary cartridge can be performed more easily.

Further, the first structural body 106 and the second structural body 107 are movable. In a case of fixing both structural bodies 106 and 107 using the latch-lock 401, these structural bodies 106 and 107 may be fixed in a desired order. However, in a case where any one of these structural bodies 106 or 107 is fixed by the capillary head pressing member, the structural body on a side where the structural body is fixed by the capillary head pressing member and the capillary head are connected to each other, and after the structural body is fixed by the capillary head pressing member, the structural body that is fixed by the latch-lock 401 and the capillary head are connected to each other and are fixed each other. Further, also in a case where any one of the first structural body or the second structural body is movable and the movable structural body is fixed by the latch-lock, in the same manner, the connection between the fixed structural body and the capillary head is fixed by the capillary head pressing member, and thereafter, the movable structural body and the capillary head are fixed to each other by the latch-lock.

The present invention is not limited to the above-described embodiments, and further includes various modifications. For example, the above-described embodiments have been described in detail in order to facilitate the understanding of the present invention, and the present invention is not necessarily limited to those including all of the described configurations. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

### LIST OF REFERENCE SIGNS

101: capillary
102: capillary cartridge
103: gel filling unit
104: high voltage power supply
105: detection window
106: first structural body
107: second structural body
108: first capillary head
109: second capillary head
110: first capillary head pressing member
111: second capillary head pressing member
112: anode
113: cathode
114: connector of heater
115: gel supply unit
116: waste liquid tank
117: cut-away hole
118: normal threaded hole
201: heat insulation material shell
202: heat insulation material
203: heater shell
204: heater unit
205: guide structure
206: planar heater
207: metal plate
208: insulation sheet
209: heat radiation sheet
301: first structural body movable in θ direction
302: second structural body movable in θ direction
303: protruding portion for fixing capillary cartridge 102
304: structure that engages with protruding portion
401: latch-lock
402: structural body for hooking latch-lock
403: guide structure of structural body
404: rubber plug

1. A capillary electrophoresis device comprising:
a capillary cartridge in which a capillary is positioned;
a first structural body in which a flow path to which one end of the capillary is connected is formed; and
a second structural body in which a flow path to which the other end of the capillary is connected is formed, wherein
at least any one of the first structural body or the second structural body is movable within a predetermined range.

2. The capillary electrophoresis device according to claim 1, wherein
at least any one of the first structural body or the second structural body is rotatable about an axis portion.

3. The capillary electrophoresis device according to claim 2, wherein
at least any one of the first structural body or the second structural body that is rotatable about an axis portion has a protruding portion for fixing the capillary cartridge, and
the capillary cartridge has a recessed portion which engages with the protruding portion.

4. The capillary electrophoresis device according to claim 1, wherein
at least any one of the first structural body or the second structural body is movable in a horizontal direction within a predetermined range, and
at least any one of the first structural body or the second structural body which is movable in the horizontal direction within the predetermined range has a latch-lock for fixing the capillary cartridge.

5. The capillary electrophoresis device according to claim 1, wherein yp2 the capillary cartridge is comprised of: a heat insulation material shell having a heat insulation material;
and a heater shell having a heater unit,
the heat insulation material shell has a guide structure for positioning the capillary, and
a heater unit of the heater shell has a groove with which the guide structure engages.

6. The capillary electrophoresis device according to claim 5, wherein
the heater unit has a multilayered structure constituted of a heater, a metal plate, an insulation sheet, and a heat radiation sheet.

7. A capillary cartridge for positioning a capillary comprising:
a heat insulation material shell having a heat insulation material; and
a heater shell having a heater unit, wherein
the heat insulation material shell has a guide structure for positioning the capillary, and
the heater unit has a groove with which the guide structure engages.

8. The capillary cartridge according to claim 7, wherein
the guide structure has a cut-away portion in which the capillary is disposed.

9. The capillary cartridge according to claim 7, wherein
the heater unit has a multilayered structure constituted of a heater, a metal plate, an insulation sheet, and a heat radiation sheet.
